(19) United States
(12) Patent Application Publication
(10) Pub. No.: US 2006/0029805 A1
(43) Pub. Date: Feb. 9, 2006

(54) High thermal conductivity graphite and method of making

(76) Inventors: Peter J. Pappano, Oak Ridge, TN (US); Timothy D. Burchell, Oak Ridge, TN (US); Douglas Wilson, Weddington, NC (US)

Correspondence Address: CURATOLO SIDOTI CO., LPA, 24500 CENTER RIDGE ROAD, SUITE 280, CLEVELAND, OH, 44145, US

(21) Appl. No.: 10/965,480

(22) Filed: Oct. 14, 2004

Related U.S. Application Data
(60) Provisional application No. 60/510,816, filed on Oct. 14, 2003.

(51) Int. Cl. B32B 9/00

(52) U.S. Cl. 428/408; 264/29.1

(57) ABSTRACT

A fully dense, high thermal conductivity graphite can be manufactured in a single hot-pressing step, without the need for multiple re-impregnation and baking steps as required in the standard processes. The ingredients of the blend, namely graphite filler which may or may not be reduced in size, and a binder, are dry mixed at room temperature, below the melting point of the binder, avoiding the requirement to maintain the binder at an elevated temperature prior to mixing.

### CROSS REFERENCE TO RELATED APPLICATIONS

This application claims the benefit of the filing date of United States Provisional Application for Patent Ser. No. 60/510,816 filed Oct. 14, 2003.

### GOVERNMENT RIGHTS STATEMENT

The work described herein was funded in part by DOE B&R Code 650103000 and Contract No. CRADA ORNL 02-0643. The U.S. Government may have certain rights in this invention.

### BACKGROUND

The traditional method for producing graphite in an industrial setting involves several key steps. High quality needle cokes are ground to desired particle size distributions and calcined in order to drive off moisture and volatile matter. The calcined coke is then mixed with molten coal tar pitch binder for a set duration, after which time the mixture is extruded into a viscoelastic, or green shape. The amount of binder added and duration of mixing affects the properties of the final graphite article, so these variables can be altered based on the properties desired by the customer. The binder pitch is received from the supplier hot (above softening point) and must be stored at this elevated temperature prior to use. Storage of the pitch at elevated temperature is both expensive and potentially deleterious to the properties of the final graphite article.

Following extrusion, the green article is then cooled in a bath of constant temperature water. After cooling, the green article is baked in order to drive off volatile matter and other light compounds. The baking step decreases the density of the piece, so additional impregnation and baking steps are performed in order to densify the baked article. The number of impregnation and baking steps is dependent on the final density desired; numerous (greater than 3) impregnation steps are sometimes performed in order to produce as dense a piece of graphite as possible. Following the final baking step, the baked article is graphitized, either by length-wise or Acheson graphitization, to approximately 3000° C. The graphitized piece is then machined to specific sizes, creating an abundance of fine graphite dust and particles.

U.S. Pat. No. 4,046,863 to Kobayashi et al discloses a process for the production of shaped articles of high density graphite. The graphite article is synthesized from a binder-less mixture of amorphous carbon powder, and has a bulk density of at least about 2.0 g/cc.

U.S. Pat. No. 4,592,968 to Taylor discloses an electrochemical cell separator plate formed from dry graphite and dry coke which are mixed with dry powdered phenolic resin for a sufficient period of time to achieve a uniform mix. Any dry mixing process can be utilized to accomplish the homogenous powder of the components.

U.S. Pat. No. 4,847,021 to Montgomery et al. discloses a process for producing high density carbon and graphite articles. The graphite article is synthesized from a blend of carbonaceous powders and a high coking value pitch (e.g. mesophase pitch) formed into shaped bodies and then simultaneously compressed and baked in an envelope of finely divided, non-reactive particles, followed by graphitizing, if required, to produce high strength, high density carbon or graphite articles.

U.S. Pat. No. 4,226,900 to Carlson et al. discloses the manufacture of high density, high strength isotropic graphite. The graphite article is produced by impregnation of pre-formed isotropic graphite substrates of high density.

Therefore, it is desirable to produce high density, high conductivity graphite using a single hot-pressing step, without the need for multiple re-impregnation and baking steps as required in the prior art.

### SUMMARY

A method of making a high density and high conductivity graphite article is provided which comprises providing graphite filler; mixing the graphite filler with at least one of a powdered mesophase pitch binder or powdered phenolic resin binder at a temperature below the melting point of the powdered mesophase pitch binder or the powdered phenolic resin binder to form a mixture; transferring the mixture to a mold; and heating the mixture and applying pressure to the mixture in the mold to form a green body, cooling the body and removing the body from the mold, and heat-treating the body.

A graphite article is provided which is made by providing graphite filler; mixing the graphite filler with at least one of a powdered mesophase pitch binder or powdered phenolic resin binder at a temperature below the melting point of the powdered mesophase pitch binder or the powdered phenolic resin binder to form a mixture; transferring the mixture to a mold; and heating the mixture and applying pressure to the mixture in the mold to form a green body, cooling the body and removing the body from the mold, and heat-treating the body.

### BRIEF DESCRIPTION OF THE DRAWINGS

FIG. 1 is a photograph of the microstructure of jet-milled graphite with mesophase pitch derived binder.

FIG. 2 is a photograph of increased magnification of the microstructure of jet-milled graphite with mesophase pitch derived binder.

FIG. 3 is a photograph of the microstructure of water comminuted graphite with mesophase pitch derived binder.

FIG. 4 is a photograph of increased magnification of the microstructure of water comminuted graphite with mesophase pitch derived binder.

### DETAILED DESCRIPTION

The present high thermal conductive graphite article is manufactured from graphite filler and a powdered mesophase pitch binder or phenolic resin binder. High thermal conductivity graphites are useful for heat exchanger applications in corrosive environments where metals cannot be used. Moreover, they are used for thermal management applications in aerospace and space applications, as well as electronic component (chip) cooling.

An unexpected outcome of the disclosed method for graphite manufacture was the discovery that a fully dense, high thermal conductivity graphite could be manufactured in a single hot-pressing step, without the need for multiple re-impregnation and baking steps as is required in the standard prior art graphite manufacturing process. Additionally, the ingredients of the blend are dry mixed at room temperature which represents a departure from the prior art where mixing is performed at a temperature above the melting point of the pitch. This removes the requirement to store and maintain the binder pitch at an elevated temperature prior to mixing, as storage of the pitch at elevated temperature is both expensive and potentially deleterious to the properties of the final graphite article.

In an embodiment, a method for forming a graphite article comprises mixing the graphite filler at room temperature (about 20° C. (Centigrade) to about 30° C.; i.e. the binder is well below its softening point) with either: (1) dry powdered mesophase pitch, or (2) dry powdered phenolic resin, in about a 3:1 ratio of filler to binder. The mixture is transferred to a matched steel mold and the mold placed in-between plates on a press. The mold is heated to the softening point of the binder; about 130° C. for powdered phenolic resin binder, and about 285° C. for the mesophase pitch binder; and, then pressure is applied to compress the blend. The molding pressure is about 800 pounds per square inch (psi). The mold is allowed to cool under pressure to a temperature of about 15° C. to about 30° C., after which the graphite preform is removed from the mold and heat-treated (to undergo graphitization), to about 2,800° C. under flowing argon, with a hold at temperature for about one hour. Microstructural examination reveals evidence that the method for forming a graphite article preferably aligns the filler particles perpendicular to the molding direction.

In an embodiment, the mixing of the graphite filler with: (1) dry powdered mesophase pitch, or (2) dry powdered phenolic resin is at a temperature of about 120° C. to about 130° C. In another embodiment the mixture of filler and binder in the mold is heated to a temperature of about 100° C. to about 180° C. In another embodiment the mixture of filler and binder in the mold is heated to a temperature of about 250° C. to about 350° C. In certain embodiments the mixture of filler and binder in the mold is cooled to a temperature of about 15° C. to about 30° C.

In certain embodiments the binder to filler ratio can vary from equal parts (1:1) to the point at which there is nearly too little binder to hold the piece together (5:1).

In certain embodiments, the final heat-treatment (graphitization) temperature can vary from about 2,400° C. to 3,000° C. under flowing argon.

In certain embodiments, the pressing pressure may be from about 1,500 pounds per square inch (psi) to about 2,500 pounds per square inch (psi) applied to the mold, which corresponds to about 750 pounds per square inch (psi) to about 900 pounds per square inch (psi) pressure in the mold. It is thought that as the pressure increases, the density of the graphite article increases.

In certain embodiments, no boride or boron containing compounds are used. In certain embodiments, the graphite article is heat-treated under flowing argon or nitrogen.

In certain embodiments, the graphite article made by the above process has a thermal conductivity of about 150 W/mk to about 250 W/mk. In one embodiment, the graphite article has a thermal conductivity of about 200 W/mk.

In certain embodiments, the graphite article made by the above process has a density of about 1.86 to about 1.99. In one embodiment, the graphite article has a density of about 1.9 g/cm³.

The graphite filler that is used in the subject process can be in the form of lathe turnings from graphite electrodes. The graphite filler can be used in an unprocessed form, or can be reduced to a powder by jet-milling wherein, air is used to accelerate particles so they collide with, and crack each other, thus achieving an overall particle size reduction. Water comminution can also be used to reduce the graphite filler to powder by using a known process invented by Cornerstone Technologies of Wilkes Barre, Pa., which uses high pressure liquid to break materials into tiny particles, generally under 20 μm (microns) in size. An example of graphite filler suitable for use includes, but is not limited to, SGL Carbon grade CG71 sold by SGL of Wiesbaden, Germany. In certain embodiments, the particle size of the filler is about 111 μm (microns) to about 15 μm (microns). In one embodiment, the particle size of the filler is about 19.75 μm (microns).

Mesophase pitch is a carbonaceous pitch (isolated from petroleum or coal tar) that goes through a mesophase state, i.e. a liquid crystal state, during thermal conversion to a graphite. Mesophase pitch can be produced by the thermal or catalytic polymerization of a suitable petroleum or coal-tar pitch. When a highly aromatic pitch, such as a decant oil pitch, is heated to temperatures of 400° C. to 450° C. for approximately 40 hours, about 45 to 65 percent of the pitch will transform from an isotropic material to an optically active anisotropic fluid phase that is, a mesophase of liquid crystal. A free-radical mechanism is believed to be responsible for polymerization of the carbonaceous material.

Another method used to produce mesophase pitch is to use solvents such as benzene, heptane, and toluene to first extract a portion of the isotropic pitch. The solvent insoluble portion can be converted to an anisotropic pitch by heating to between about 230° C. and about 400° C. for less than 10 minutes. The anisotropic, or oriented, phase is composed of stacked, polynuclear aromatic hydrocarbon molecules. These molecules tend to be disc-shaped with an average molecular weight of approximately 1,000 (although the molecular weight can vary considerably). The molecular structure of the mesophase produced from coal-tar pitch is characterized by higher aromaticity, whereas the structure of petroleum-derived mesophase is more open because of its higher content of aliphatic side chains.

Initially, small spheres of mespohase form in the isotropic pitch when heated for an adequate time at a sufficiently high temperature. Upon further heating, the concentration of mesophase spheres increases and causes the spheres to collide and coalesce, creating a mosaic-like, nematic liquid-crystal structure.

Mesophase products that have a high average molecular weight and no side groups or small molecular components to cause disordering, often decompose before becoming fluid enough to flow. Because of this, the mesophase used to melt spin fibers is normally a mixture of high molecular weight molecules that still have a small number of side groups. Therefore, commercial mesophase precursors have certain characteristics of both mixtures and solutions: they soften over a range of temperatures and orient under an applied stress. An example of mesophase pitch binder suitable for use includes, but is not limited to, Mesophase Pitch AR, synthesized by Mitsubishi Gas Chemical Company Inc., Tokyo, Japan.

Phenolic resin is an organic compound that does not undergo a mesophase transition, but rather forms a disordered crystal structure during thermal conversion to a carbon. An example of phenolic resin binder suitable for use includes, but is not limited to, Durez 5034, produced by Occidental Chemical Corp., Dallas, Tex.

“Acicular nature” as used in this disclosure defines the shape of the article, wherein the article has a needle, or needle like shape, i.e. long and thin. “Anisotropy” as used in this disclosure relates to the properties of the artifact, wherein the artifact exhibits different properties in different directions because of a preferred orientation at the molecular level. In the case of graphite, the crystal structure is highly anisotropic because bonds in the crystallographic a-direction are strong covalent bonds, whereas bonds in the crystallographic c-direction are weak van der Waals bonds.

“In plane” as used in this disclosure refers to an orientation parallel to the molecular orientation of the atoms, or the a-direction. “Out of plane” as used in this disclosure refers to an orientation perpendicular to the molecular orientation of the atoms, or the c-direction. Consequently, the thermal conductivity is much greater in the a-direction or in-plane direction.

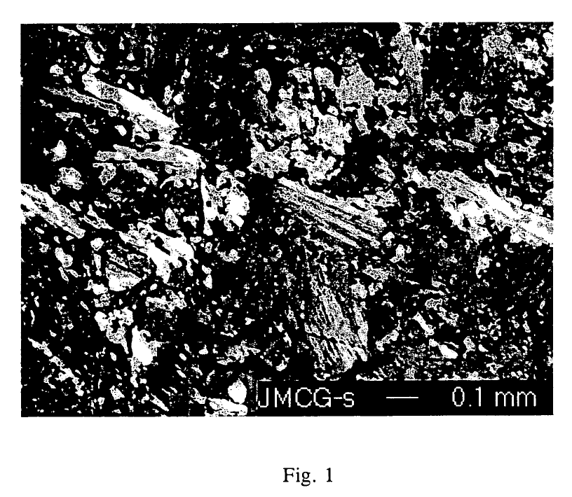

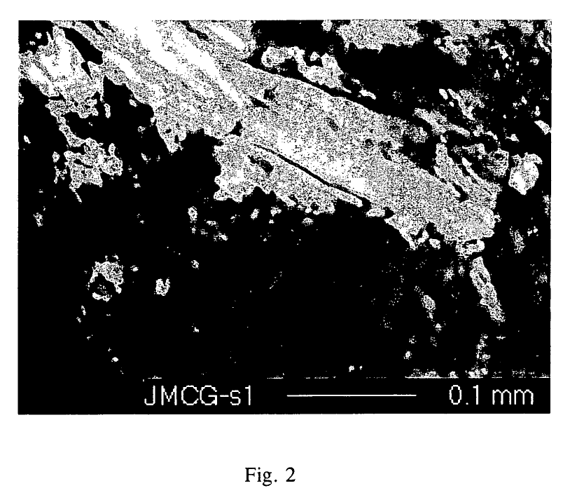

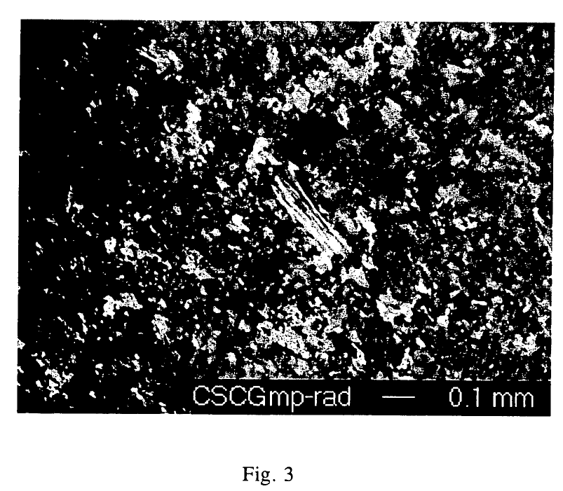

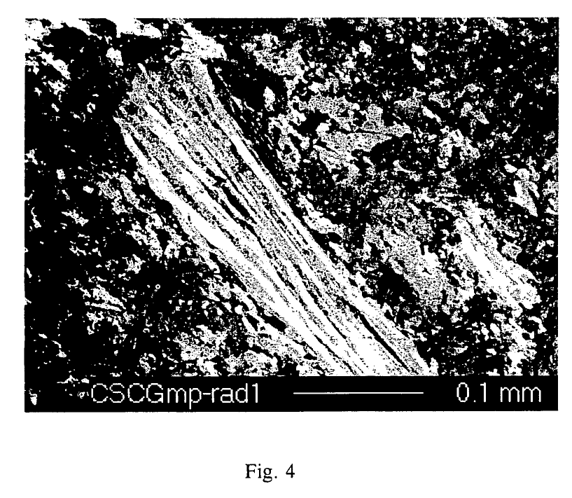

The microstructures of mesophase pitch derived binder graphites are shown in FIGS. 1 through 4. FIGS. 1 and 3 demonstrate the acicular nature of jet-milled and water comminuted graphite fillers respectively. Additionally, as shown in FIGS. 3 and 4 water comminuted filler graphite is significantly finer than the jet-milled filler graphite in FIGS. 1 and 2.

In another embodiment the graphite disclosed herein may be isostatically molded. Isostatic pressing involves the application of pressure equally to all surfaces of the feed. An isostatic press consists of a pressure vessel filled with an incompressible fluid. The feed is enclosed in a sealed elastomeric mold, immersed in the fluid, and pressurized. The fluid transfers equally to all sides of the part.

Typical densities and thermal properties for a range of graphites are presented in Table 1.

TABLE 1

| | | | Bulk Density | Thermal Conductivity |
|---|---|---|---|---|
| Graphite Type | Typical Grade | Forming Method | (g/cm³) | (W/mK) |
| Fine grained (20 μm) | SGL Carbon R6300 | Isostatically molded | 1.75 | 65 |
| Medium grained (0.8 mm) | SGL Carbon H079 | Molded | 1.66 | 150/125* |
| Coarse grain (1.6 mm) | SGL Carbon HC | Extruded | 1.71 | 139/109* |

*with grain/against grain

Fine grained density and thermal conductivity were tested in experimental graphite samples and are shown in Table 2. The graphite was produced in a single step hot-pressing process without the need for impregnation steps. The graphite filler was dry mixed at room temperature (i.e. the binder was well below its softening point) with: (1) powdered mesophase pitch or (2) powdered phenolic resin, both in a 3:1 ratio of filler to binder. The blend was transferred to a matched steel mold and the mold was placed in-between plates on a press. The mold was heated to the softening point of the binder (about 130° C. for powdered phenolic resin and about 285° C. for the mesophase pitch) and then pressure was applied to compress the blend, with the molding pressure about 800 pounds per square inch. The mold was allowed to cool under pressure, after which time the graphite preform was removed from the mold and heat-treated to about 2,800° C. under flowing argon, with hold at temperature for about one hour.

TABLE 2

| | | | | | | Thermal |
|---|---|---|---|---|---|---|
| Sam- | Pow- | | | Density | Diffusivity | Conductivity |
| ple | dered | Grain | Binder | (g/cc) | (cm²/s) | (W/mK) |
| 1 | no | OP | PR | 1.52 | 0.3349 | 36.3 |
| 2 | no | IP | PR | 1.40 | 0.5459 | 54.4 |
| 3 | JM | OP | PR | 1.77 | 0.7808 | 98.5 |
| 4 | JM | IP | PR | 1.80 | 0.9879 | 127.1 |
| 5 | JM | OP | MP | 1.86 | 0.776 | 102.8 |
| 6 | JM | IP | MP | 1.86 | 1.3105 | 173.5 |
| 7 | WC | OP | PR | 1.56 | 0.5549 | 61.6 |
| 8 | WC | IP | PR | 1.71 | 0.9273 | 113.0 |
| 9 | WC | OP | MP | 1.99 | 0.5392 | 76.8 |
| 10 | WC | IP | MP | 1.96 | 1.4601 | 204.4 |

no = no powdering
JM = jet milled
WC = water comminuted
PR = phenolic resin
MP = mesophase pitch
OP = out of plane
IP = in plane

The data in Table 2 shows that graphites made from non-powdered graphite filler exhibited a lower thermal conductivity than either the materials made from jet-milled or water comminuted powdered graphite filler. The combination of texture (preferred alignment) and the acicular nature of the filler graphite would be expected to cause anisotropy in the graphite articles. The thermal conductivity data presented below reveals the presence of anisotropic behavior, with the anisotropy more marked in the case of the water comminuted graphite.

Further, the samples prepared with a mesophase pitch binder yielded higher thermal conductivity values than similar materials produced with a phenolic resin binder. Carbon derived from phenolic resin binder exhibited a glassy structure with poor thermal conductivity, whereas, mesophase pitch derived graphite exhibited a highly ordered three-dimensional structure with high thermal conductivity.

The graphite produced from water comminuted graphite filler with a mesophase pitch derived binder exhibited a density of greater than 1.9 g/cm³ and thermal conductivities of 204.4 W/mK and 76.8 W/mK in the in-plane and out-of-plane directions, respectively.

It should be noted that the graphite was produced in a single step hot-pressing process without the need for impregnation steps. Graphite manufactured from mesophase pitch and jet-milled graphite filler also exhibited a relatively high thermal conductivity (173.5 W/mK in-plane), but showed less anisotropy (102.8 W/mK out-of-plane). The difference in anisotropy between the jet-milled and water comminuted produced materials is attributed to increased acicularity in the case of the water comminuted material. A similar trend in anisotropy was noted for the phenolic resin derived graphites.

The thermal conductivity values for these fine-grained graphites were superior to other commercially available materials, such as the graphites known in the prior art and reported in Table 1. The high density and high with-grain thermal conductivity of the mesophase pitch binder, fine grained graphite disclosed herein was unexpected. Moreover, the synthesis of the high density, high thermal conductivity graphite in a single hot-pressing step, without the need for multiple reimpregnation and baking steps, was wholly unexpected.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

What is claimed is:

1. A method of making a high density and high conductivity graphite article comprising:
a. providing graphite filler;
b. mixing the graphite filler with at least one of a powdered mesophase pitch binder or powdered phenolic resin binder at a temperature below the melting point of the powdered mesophase pitch binder or the powdered phenolic resin binder to form a mixture;
c. transferring the mixture to a mold;
d. heating and applying pressure to the mixture in the mold to form a green body;
e. cooling and removing the body from the mold;
f. heat-treating the body.

2. The method of claim 1 wherein the particle size of the graphite filler is about 15 μm to about 111 μm.

3. The method of claim 1 wherein the particle size of the graphite filler is about 19 μm.

4. The method of claim 1 including water comminuting the graphite filler.

5. The method of claim 1 including jet milling the graphite filler.

6. The method of claim 1 wherein the mixing of the graphite filler with at least one of a powdered mesophase pitch binder or powdered phenolic resin binder at a temperature below the melting point of the powdered mesophase pitch binder or the powdered phenolic resin binder is at a temperature of about 20° C. to about 30° C.

7. The method of claim 1 wherein the mixing of the graphite filler with at least one of a powdered mesophase pitch binder or powdered phenolic resin binder is at a temperature below the melting point of the powdered mesophase pitch binder or the powdered phenolic resin binder is at a temperature of about 120° C. to about 130° C.

8. The method of claim 1 including heating the mixture in the mold to a temperature of about 250° C. to about 350° C.

9. The method of claim 1 including heating the mixture in the mold to a temperature of about 285° C.

10. The method of claim 1 including heating the mixture in the mold to a temperature of about 100° C. to about 180° C.

11. The method of claim 1 including heating the mixture in the mold to a temperature of about 130° C.

12. The method of claim 1 including cooling the mixture to a temperature of about 15° C. to about 30° C.

13. The method of claim 1 wherein the ratio of graphite to at least one of a non-liquid resin or binder is about 1:1 to about 5:1.

14. The method of claim 1 wherein the ratio of graphite to at least one of a non-liquid resin or binder is about 3:1.

15. The method of claim 1 wherein the mold is a matched steel mold.

16. The method of claim 1 including applying about 1,500 pounds per square inch (psi) to about 2,500 pounds per square inch (psi) of pressure to the mold.

17. The method of claim 1 including applying about 2,000 pounds per square inch (psi) of pressure to the mold.

18. The method of claim 1 wherein the pressure in the mold is about 750 pounds per square inch (psi) to about 900 pounds per square inch (psi).

19. The method of claim 1 wherein the pressure in the mold is about 800 pounds per square inch (psi).

20. The method of claim 1 wherein the body is heat treated to about 2,400° C. to about 3,000° C. under flowing argon.

21. The method of claim 1 wherein the body is heat treated to about 2,800° C. under flowing argon.

22. The method claim 1 wherein the mixture is heat treated under flowing argon for about an hour.

23. The method of claim 1 wherein no boride or boron containing compounds are used.

24. A graphite article made by the method of claim 1.

25. The graphite article of claim 24 wherein the graphite article has a thermal conductivity of about 150 W/mk to about 250 W/mk.

26. The graphite article of claim 24 wherein the graphite article has a thermal conductivity of about 200 W/mk.

27. The graphite article of claim 24 wherein the article has a density of about 1.86 g/cc to about 1.99 g/cc.

28. The graphite article of claim 24 wherein the article has a density of about 1.9 g/cm³.
